(19) United States
(12) Patent Application Publication
(10) Pub. No.: US 2024/0429631 A1
(43) Pub. Date: Dec. 26, 2024

(54) COUPLING DEVICE CONFIGURED TO PROVIDE BALANCED COUPLING FOR SINGLE PAIR ETHERNET CABLE

(71) Applicant: BELDEN CANADA ULC, SAINT-LAURENT (CA)

(72) Inventors: Virak SIEV, Montreal (CA); Michael BODZAY, Dollard-Des Ormeaux (CA)

(73) Assignee: BELDEN CANADA ULC, SAINT-LAURENT (CA)

(21) Appl. No.: 18/752,285

(22) Filed: Jun. 24, 2024

Related U.S. Application Data
(60) Provisional application No. 63/522,782, filed on Jun. 23, 2023.

(51) Int. Cl. H01R 9/24; H01R 13/6461; H01R 13/6591

(52) U.S. Cl. CPC H01R 9/2458; H01R 13/6461; H01R 13/65912

(57) ABSTRACT

A balancing coupling device is configured to balance electrical coupling of a single pair ethernet cable to a data conductor portion connected with a terminal block connector portion. The balancing coupling device includes a connecting portion structurally configured to connect to a shield portion of the single pair ethernet cable and a balancing coupling portion configured to extend from the connecting portion. The balancing coupling portion includes a first balancing portion and a second balancing portion, the first balancing portion is configured to be connected within at least a portion of a first terminal block connector portion that is configured to be located adjacent to a second terminal block connector portion that is configured to be connected with a first data conductor portion of the single pair ethernet cable, the second balancing portion is configured to be connected within at least a portion of a third terminal block connector portion that is configured to be located adjacent to a fourth terminal block connector portion that is connected with a second data conductor of the single pair ethernet cable, the fourth terminal block connector portion is configured to be located adjacent to the third terminal block connector portion, and the first balancing coupling portion and the second data coupling portion are configured such that the coupling of the first data conductor is balanced with the coupling of the second data conductor so as to reduce alien crosstalk of the single pair ethernet cable.

### CROSS REFERENCE TO RELATED APPLICATION

This application claims the benefit of U.S. Provisional Application No. 63/522,782, filed Jun. 23, 2023, the disclosure of which is hereby incorporated by reference herein in its entirety.

### TECHNICAL FIELD

The present disclosure generally relates to a terminal block connector for connecting ethernet cables. More specifically, the disclosure relates to such a terminal block connector device for connecting single pair ethernet cables that provides balanced cross talk performance.

### BACKGROUND

Traditionally, terminal block connectors were designed to connect cables carrying power or control signals, but not data signals. Therefore, transmission parameters like crosstalk and balance that may occur with cables carrying data signals weren't considered during the design. In recent development, these connectors could also be used to connect cables carrying data signals (like with Single Pair Ethernet (SPE)) which may result in improper balance and excessive crosstalk.

FIG. 1 illustrates a typical terminal block connector 100. The terminal block connector 100 may be used to make an electrical connection between individual conductors. The terminal block connector 100 typically has a plastic body 102, receiving portions 104 for receiving the conductors to be connected, plates 106, a bar 108 and screws 110. After inserting conductors to be connected in the receiving portions 104 with a first conductor of a first SPE cable to be connected inserted at a top of the terminal block connector and a second conductor of a second SPE cable to be connected being inserted at a bottom of the terminal block connector, the conductors may be in contact with the plates 106 and/or the bar 108 and the screws may be adjusted such that the conductors are pressed against the bar 110 to make an electrical connection between the conductors. In some embodiments, the terminal block connectors 100 may be colored corresponding to the conductors to be connected.

In a typical SPE terminal block deployment, each corresponding conductor of an SPE cable is connected to its own terminal block 100. For example, as shown in FIG. 2, a first data conductor 210 may be connected to a red terminal block connector 204, a second data conductor 208 may be connected to a black terminal block connector 202, and a shield conductor 212 (if present) may be connected to a gray terminal block connector 206. In a typical deployment, the terminal block connectors may be placed or mounted directly adjacent to one another in a row as illustrated. As such, the gray terminal block (if present) would be placed either to the left or right of the two data terminal blocks.

This spacing of the conductors within the terminal block connectors and the spacing of the terminal block connectors next to each other causes an imbalanced coupling within a pair of the SPE conductors, and between adjacent pairs of the SPE conductors, as shown in FIG. 3. The coupling is illustrated herein as capacitances, although no actual capacitors are present. Within a pair of the SPE conductors, the coupling is shown as the C1 and C2 capacitances, between the black conductor 302 and the shield conductor 306, and between the red conductor 304 and the shield conductor 306, respectively. Because the red terminal block connector is closer to the gray terminal block connector, the C2 capacitance is much greater than the C1 capacitance (i.e., C2 is dominant). This inequivalence between C1 and C2 is the imbalanced coupling (or noise) within a conductor pair.

Between adjacent pairs, coupling passes via the gray terminal block. The black terminal block of pair 2 is closer to the gray terminal block of pair 1, therefore the C3 capacitance is greater (i.e., dominant) than C4. The two dominant capacitances (C2 and C3) create an imbalanced coupling between adjacent pairs (i.e., Alien Crosstalk).

The imbalances described above will deteriorate the cabling system's ability to transmit data signals. It should be noted that a similar imbalance exists between adjacent pairs if the gray terminal blocks are removed (i.e., a UTP system)

It may therefore be desirable to provide a way to balance the crosstalk or noise that may be present on such SPE conductors when connected with terminal block connectors.

### SUMMARY

According to embodiments of the disclosure, a coupling device is configured to balance electrical coupling of a single pair ethernet cable to a data conductor portion connected with a terminal block connector portion. The coupling device includes a connecting portion structurally configured to connect to a shield portion of the single pair ethernet cable and an extension portion configured to extend from the connecting portion. The extension portion includes a first extension portion and a second extension portion, the first extension portion is configured to be connected within at least a portion of a first terminal block connector portion that is configured to be located adjacent to a second terminal block connector portion that is configured to be connected with a first data conductor portion of the single pair ethernet cable, the second extension portion is configured to be connected within at least a portion of a third terminal block connector portion that is configured to be located adjacent to a fourth terminal block connector portion that is connected with a second data conductor of the single pair ethernet cable, the fourth terminal block connector portion is configured to be located adjacent to the third terminal block connector portion, and the first extension portion and the second extension portion are configured such that the coupling of the first data conductor is balanced with the coupling of the second data conductor so as to reduce alien crosstalk of a single pair ethernet cabling system.

According to embodiments of the disclosure, a coupling device configured to balance electrical coupling of a single pair ethernet cable to a data conductor portion connected with a terminal block connector portion. The coupling device includes a connecting portion structurally configured to connect to a shield portion of a single pair ethernet cable and an extension portion configured to extend from the connecting portion. The extension portion includes a first extension portion and a second extension portion configured to extend along a first data conductor portion of the single pair ethernet cable and along a second data conductor portion of the single pair ethernet cable, respectively, the first extension portion is configured to be connected within at least a portion of a first terminal block connector portion that is configured to be located adjacent to a second terminal block connector portion that is configured to be connected with the first data conductor portion of the single pair ethernet cable, the second extension portion is configured to be connected within at least a portion of a third terminal block connector portion that is configured to be located adjacent to a fourth terminal block connector portion that is connected with the second data conductor of the single pair ethernet cable, the fourth terminal block connector portion is configured to be located adjacent to the third terminal block connector portion, and the coupling device is configured such that electrical coupling of the first data conductor portion to the first extension portion is balanced with electrical coupling of the second data conductor portion to the second extension portion so as to reduce alien crosstalk of a single pair ethernet cabling system.

According to embodiments of the disclosure, a coupling device configured to balance electrical coupling of a single pair ethernet cable to a data conductor portion connected with a terminal block connector portion. The coupling device includes an extension portion that includes a first extension portion and a second extension portion configured to extend along a first data conductor portion of the single pair ethernet cable and along a second data conductor portion of the single pair ethernet cable, respectively, the first extension portion is configured to be connected within at least a portion of a first terminal block connector portion that is configured to be located adjacent to a second terminal block connector portion that is configured to be connected with the first data conductor portion of the single pair ethernet cable, the second extension portion is configured to be connected within at least a portion of a third terminal block connector portion that is configured to be located adjacent to a fourth terminal block connector portion that is configured to be connected with the second data conductor portion of the single pair ethernet cable, the fourth terminal block connector portion is configured to be located adjacent to the third terminal block connector portion, the first extension portion and the first data conductor portion are configured to form a first spacing portion and a first electrical coupling level, the second extension portion and the second data conductor portion are configured to form a second spacing portion and a second electrical coupling level, and the first spacing portion and the second spacing portion are configured such that the first electrical coupling level is balanced with the second electrical coupling level so as to reduce alien crosstalk of a single pair ethernet cabling system.

### BRIEF DESCRIPTION OF THE DRAWINGS

Further advantages and features of the present disclosure will become apparent from the following detailed description and the accompanying drawings.

FIG. 1 illustrates a terminal block connector in accordance with various aspects of the disclosure.

FIG. 2 illustrates terminal block connectors in accordance with various aspects of the disclosure.

FIG. 3 illustrates imbalanced coupling of SPE conductors in accordance with various aspects of the disclosure.

FIG. 4 illustrates balanced coupling of SPE conductors in accordance with various aspects of the disclosure.

FIG. 5 illustrates balanced coupling of SPE conductors in accordance with various aspects of the disclosure.

FIG. 6 illustrates balanced coupling of two pairs of SPE conductors in accordance with various aspects of the disclosure.

FIG. 7 illustrates an extension element for balancing a coupling for an SPE cable in accordance with various aspects of the disclosure.

FIG. 8 illustrates an extension element for balancing a coupling and terminal block connecting devices in accordance with various aspects of the disclosure.

FIG. 9 illustrates a terminal block connecting device with a potential equalizing element in accordance with various aspects of the disclosure.

FIG. 10 illustrates alien crosstalk levels at various frequencies in accordance with various aspects of the disclosure.

FIG. 11 illustrates terminal block connecting devices with a potential equalizing element in accordance with various aspects of the disclosure.

FIG. 12 illustrates a potential equalizing element in accordance with various aspects of the disclosure.

FIG. 13 illustrates a potential equalizing element in accordance with various aspects of the disclosure.

FIG. 14 illustrates a potential equalizing element in accordance with various aspects of the disclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure. Furthermore, the terminology used herein is used only for the purpose of describing particular embodiments of the present disclosure and is not intended to be limiting in any way.

As used in the specification and the appended claims, the singular form “a,” “an,” and “the” include plural referents unless the context clearly indicates otherwise. For example, reference to a component in the singular is intended to also include a plurality of components.

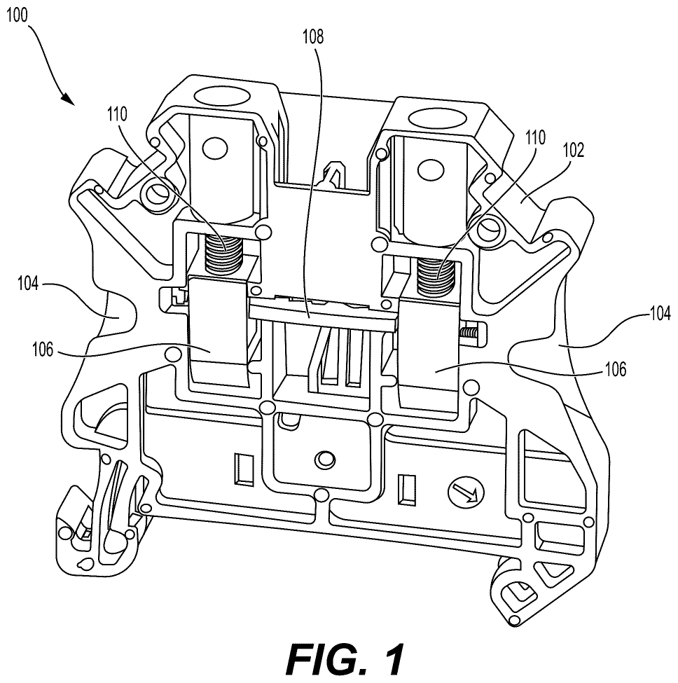

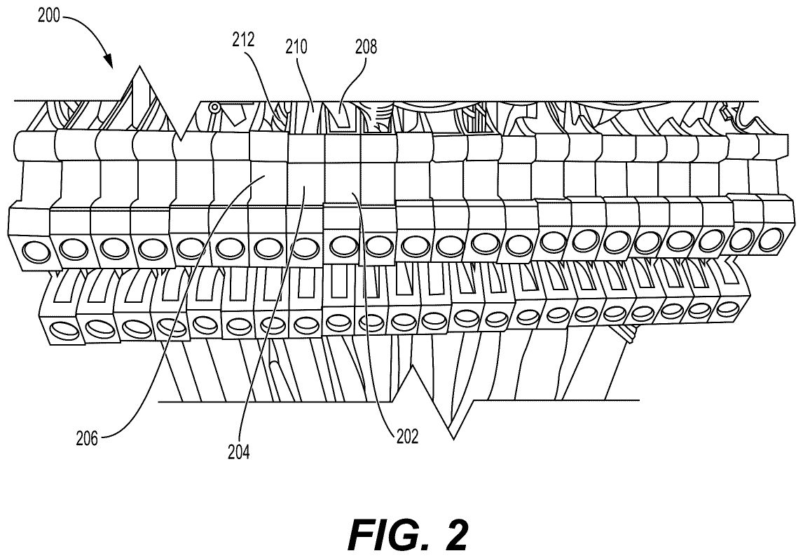

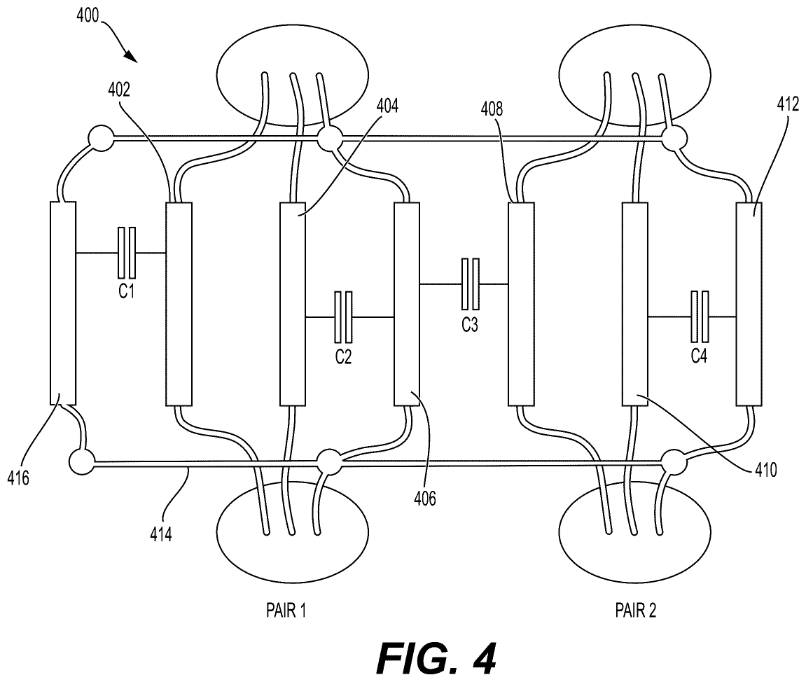

FIG. 4 illustrates an exemplary embodiment that may be used in conjunction with the aspects disclosed herein. In FIG. 4, conductors of first and second SPE cables may be connected. The data conductors 402, 404, 408 and 410 and the shield conductors 406, 412 and 416 may be connected through the use of a plurality of terminal block connectors 100, 200 such as illustrated in FIGS. 1 and 2. As explained herein, when the terminal block connectors 100, 200 with the SPE conductors are positioned in a manner such as illustrated in FIG. 2, imbalanced coupling (crosstalk) is present between the adjacent pairs of the conductors.

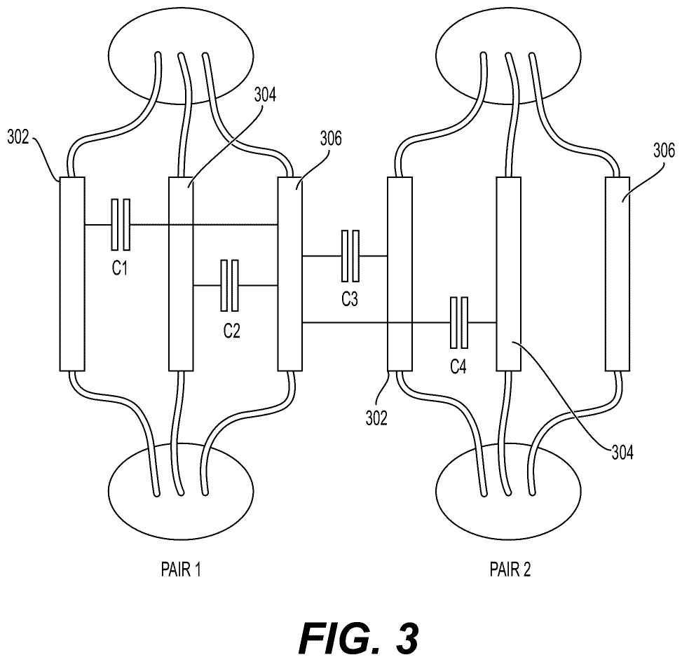

Within a pair, the coupling is represented in the figures as the capacitances, such as the C1 and C2 between the black conductor and shield, and between the red conductor and shield, respectively, as illustrated in FIG. 3. Because the red terminal block is closer to the gray terminal block, the C2 capacitance is much greater than the C1 (i.e., C2 is dominant). This inequivalence between C1 and C2 is the imbalanced coupling within a pair.

Between adjacent pairs, coupling passes via the gray terminal block. As illustrated in FIG. 3, the black terminal block of pair 2 is closer to the gray terminal block of pair 1, and therefore the coupling represented as the C3 capacitance is greater (i.e., dominant) than the coupling represented as the C4 capacitance. The two dominant capacitances (C2 and C3) create an imbalance in coupling between adjacent pairs (i.e., Alien Crosstalk). This imbalance in coupling may deteriorate the cabling system's ability to transmit data signals. It should be noted that a similar imbalance exists between adjacent pairs if the gray terminal blocks are removed (i.e., a UTP system).

In addition to the imbalanced nature of the coupling of the terminal block connectors, their initial design intent was for power and control signals. As such electrical transmission paths consist of large metal plates, a sheet metal element, and metal screws. And the conductor entryways are sized to accept conductors that support those levels (i.e., 16AWG and larger). All of the elements of the terminal block connectors are oversized for the SPE application, which requires current levels typically up to 2 A, and conductors sized 18AWG and smaller. The oversized conductive elements in the transmission path create a large capacitive coupling between adjacent terminal block connectors.

Embodiments disclosed herein are structurally configured to correct for balancing (equalizing) the imbalance in coupling in the terminal blocks. In particular, embodiments disclosed herein may include an extension element and/or a potential equalizing element structurally configured to equalize the coupling of the terminal blocks connected to the conductors of the SPE cable, as further described herein. As used herein, the terms balance and equalize should be construed to have a same meaning, although balance does not require exact equalization.

To correct for imbalanced couplings described herein, various embodiments may include a potential equalizing element 414 to shunt or connect the conductors of the gray (shield) terminal blocks together. An additional terminal block can also be added at the end of a row to ensure symmetry on all pairs. This can be achieved in different ways, but a goal may be to create a common shield plane between each of the pairs as shown in FIG. 4.

When the potential equalizing element 414 is employed, within a pair, the black terminal block no longer needs to ‘reach through’ the red terminal block to couple to the gray terminal block. All gray blocks are considered electrically as a single shield plane; therefore, the black terminal block can couple to the gray terminal block immediately adjacent to it. Because all terminal blocks are spaced equidistant from one another, C1 is equal to C2 and the coupling within each pair is now balanced.

As for the coupling between adjacent pairs, the same principal holds true. All gray terminal block connectors are considered as the same shield plane. The black terminal block of pair 2 couples to the gray terminal block immediately adjacent to it, and the red terminal block does similarly. Again, because the terminal block connectors are spaced equidistantly, the coupling represented as C3 is equal to the coupling represented as C4. Furthermore, because of the equidistant nature of the terminal blocks, C1=C2=C3=C4, and the coupling between pairs is balanced.

In the case of a UTP system which does not have a shield conductor, the gray terminal blocks are still used, and they are shunted together, even though they are not connected to a shield conductor from the cables. As such, the same balanced coupling results even without the shield conductor.

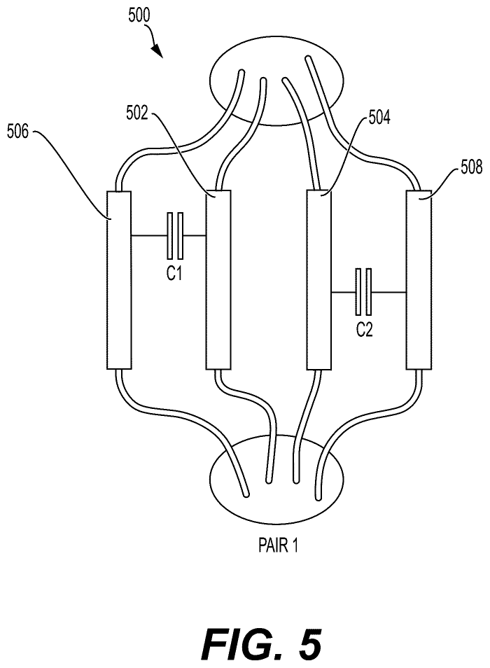

FIG. 5 illustrates an exemplary embodiment that may be used in conjunction with the aspects disclosed herein. In FIG. 5, conductors of an SPE cable may be connected. The data conductors 502, 504, and the shield conductors 506 and 508 may be connected through the use of a plurality of terminal block connectors 100, 200 such as illustrated in FIGS. 1 and 2. As explained herein, when the terminal block connectors 100, 200 with the SPE conductors are positioned in a manner such as illustrated in FIG. 2 and with only a single shield conductor such as illustrated in FIG. 3, unbalanced coupling (crosstalk) is present between the adjacent pairs of the conductors.

Within the pair, the coupling is represented as the capacitances, such as the C1 and C2 between the black conductor and shield, and between the red conductor and shield, respectively, as illustrated in FIG. 5. In this embodiment, the imbalance in coupling is addressed by having two shield conductors 506, 508 spaced a same distance on each side of the data conductors 502, 504, such that C1=C2.

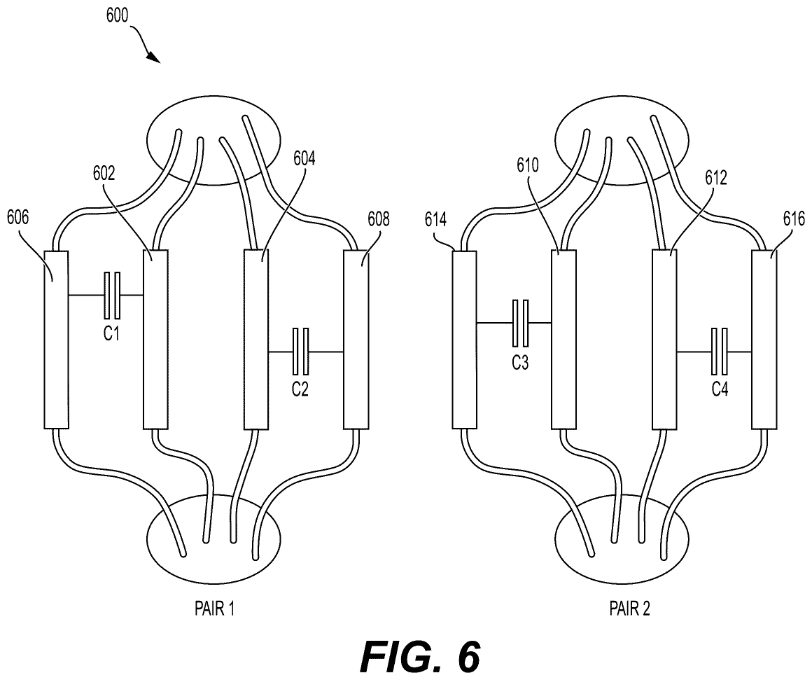

FIG. 6 illustrates an exemplary embodiment that may be used in conjunction with the aspects disclosed herein. In FIG. 6, conductors of a pair of adjacent SPE cables may be connected. The data conductors 602, 604, 610 and 612 and the shield conductors 606, 608, 614 and 616 may be connected through the use of a plurality of terminal block connectors 100, 200 such as illustrated in FIGS. 1 and 2. By using a shield conductor on each of the two sides of each pair of the data conductors, the coupling is balanced by having the two shield conductors 606, 608 and 614, 616 spaced a same distance on each side of the data conductors 602, 604, and 610, 612 such that C1=C2 and C3=C4. The shield conductors 606, 608 also reduce the amount of coupling.

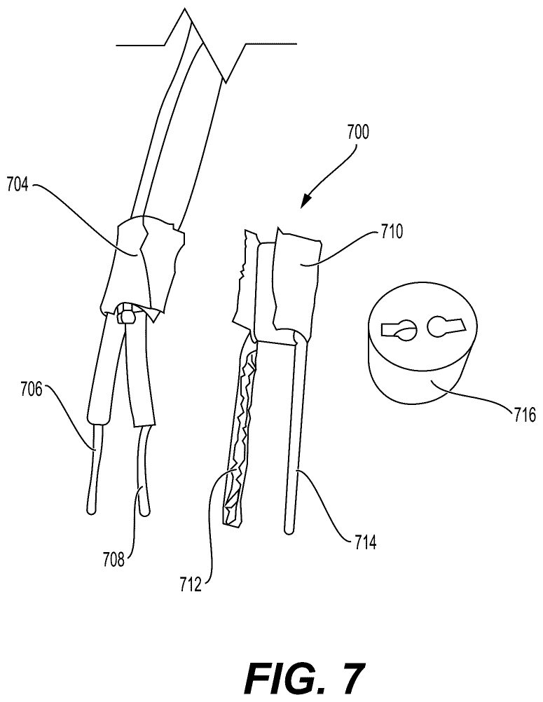

FIG. 7 illustrates an extension element 700 in accordance with various embodiments. The extension element 700 may be used to provide balanced coupling to an SPE cable 702. The SPE cable may have data conductors 706, 708 and a shield portion 704. The extension element 700 may include a connecting portion 710 configured to be connected to the shield portion 704 of the SPE cable 702, extension portions 712, 714 configured to provide a balanced coupling to the SPE cable 702 while reducing an amount of the coupling, and a cover portion 716 configured to cover the connecting portion 710 of the extension element 700. The connecting portion 710 may be formed in a semi-circular shape with a gap and may be configured to fit around and in contact with the shield portion 704.

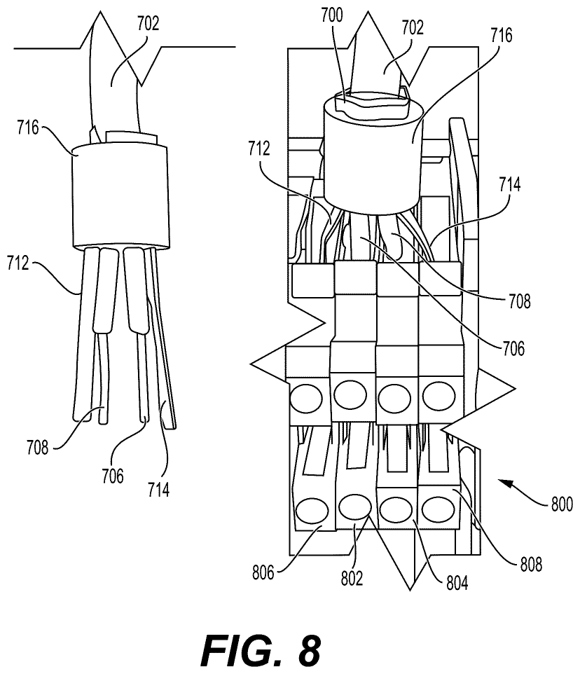

To connect the extension element 700 to the SPE cable 702, a portion of a jacket of the SPE cable 702 may be stripped back to expose the shield portion 704 at an end of the SPE cable 702 while also exposing the conductors 706 and 708. Then, the extension element 700 is slid onto the shield portion 704 with the connecting portion 710 connecting to the shield portion 704 of the SPE cable 702 as shown in FIG. 8. In various embodiments, the connecting portion 710 may be clamped or squeezed to make a strong contact with the shield portion 704. The cover portion 716 may be slid over the connecting portion 710 to protect the connecting portion. In various embodiments, the cover portion 716 may be a non-conductive material.

As also illustrated in FIG. 8, the SPE cable 702 may be connected to terminal block connectors 802, 804, 806 and 808 of a terminal block connector device 800. In various embodiments, the terminal block connectors may be color-coded to assist in proper insertion of the conductors. The data conductors 706 and 708 may be inserted into the adjacent terminal block connectors 802, 804, while the extension portions 712, 714 are inserted into the outer terminal block connectors 806, 808. In various embodiments, the extension portions 712, 714 are spaced apart from each other by a spacing configured to fit into the terminal block connectors 806, 808 and configured to be equally spaced from the adjacent data conductors 706, 708 in the terminal block connectors 806, 808 to balance (equalize) the coupling to the data conductors 706, 708.

The extension portions 712, 714 may be configured to extend from the connecting portion 710 substantially parallel to each other. The extension portions 712, 714 may be somewhat bendable allowing adjustment of the spacing distance to be connected within the terminal block connectors 806, 808.

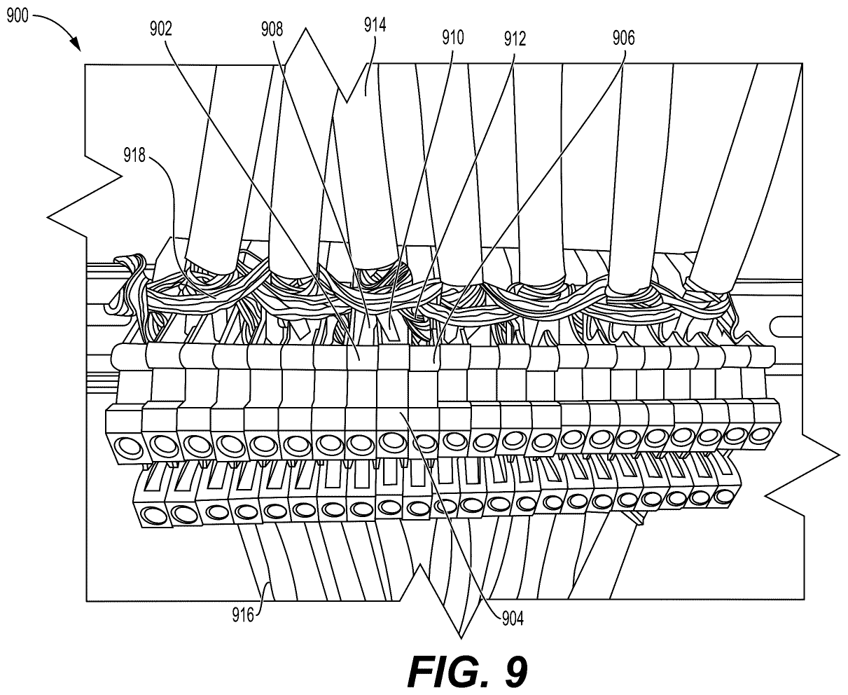

As illustrated in FIG. 9, a terminal block connector device 900 includes a plurality of red terminal block connectors 902, a plurality of black terminal block connectors 904 and a plurality of gray terminal block connectors 906 configured to receive corresponding, red, black, and grey conductors 908, 910 and 912 of a corresponding SPE cable 914. The red and black conductors 908, 910 may be data conductors, while the gray conductor 912 may be a shield conductor. The conductors of a plurality of the SPE cables may be connected to adjacent terminal block connectors as illustrated, with the terminal block connectors adjacent to each other in a row.

Another potential equalizing element 918 may include wire connected to the shield conductor 912 of each SPE cable. The previously illustrated terminal potential equalizing element 414 may be utilized with the terminal block connecting device 900 in place of or in addition to the potential equalizing element 918. Potential equalizing elements other than those illustrated may also be utilized with embodiments disclosed herein as long as they provide an equalized shield potential to each of the shield conductors of the SPE cables connected to the terminal block connecting device 900. Any of the potential equalizing elements may also be used with the extension element 700.

In some embodiments, corresponding conductors of SPE cables 916 may be connected to the bottom of the terminal block connectors to connect the corresponding conductors of the top and bottom SPE cables together. In some embodiments, the potential equalizing elements may be connected to the shieldconductors of the top and bottom SPE cables.

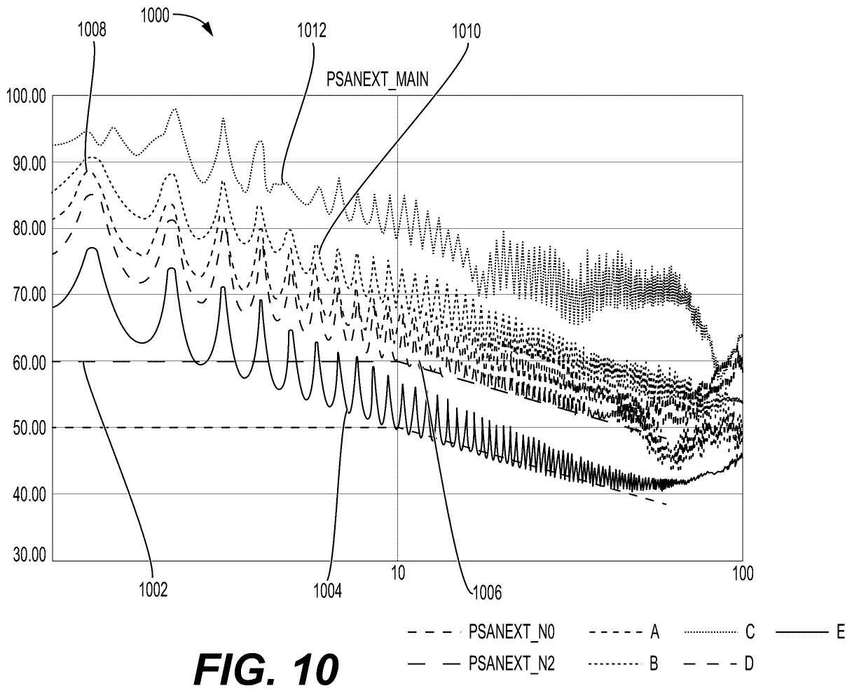

FIG. 10 illustrates alien crosstalk levels in dB at various frequencies. The line 1000 illustrates an acceptable level of alien crosstalk. The line 1002 illustrates a baseline level of alien crosstalk in a terminal block connecting device. The lines 1004 and 1006 illustrate levels of alien crosstalk in a terminal block connector device with unsuccessful crosstalk mitigation techniques. Line 1008 illustrates a crosstalk level without use of the potential equalizing elements or the extension element. Line 1010 illustrates alien crosstalk levels for the embodiments with the potential equalizing elements of FIGS. 4 and 9. Line 1012 illustrates alien crosstalk levels for the embodiments with the extension elements as illustrated in FIGS. 7 and 8. As illustrated, the potential equalizing element and the extension element both provide an improvement in the level of alien crosstalk of 3 dB or more in a cabling system. The single pair ethernet cable may be a part of a cabling system. The cabling system may include all the components used between two active equipment (like a switch and a computer) and the single pair ethernet cable may be a part of that cabling system.

By reducing alien crosstalk in the single pair ethernet cabling system, the signal to noise ratio of data transmitted by the SPE cables is improved.

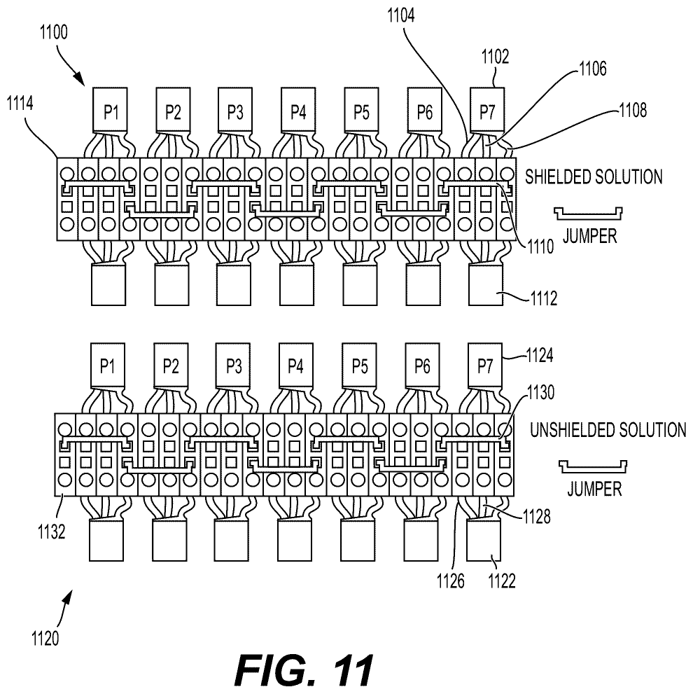

FIG. 11 illustrates terminal block connecting devices 1100, 1120 with a potential equalizing element in accordance with various aspects of the disclosure. The terminal block connecting device 1100 includes a plurality of terminal block connectors for connecting conductors of 1104, 1106 and 1108 of SPE cables 1102, 1112. In this embodiment, the shield conductors 1108 are connected together by the jumpers 1110 connected to adjacent white terminal block connectors. The jumpers 1110 combined with the structure of the white terminal block connectors act as the potential equalizing element structurally configured to provide an equal potential to each of the shield conductors of the SPE cables 1102, 1112 and are configured to provide the balanced level of crosstalk. An optional white terminal block connector 1114 has been added at the end of the row of terminal block connectors as discussed herein.

The terminal block connecting device 1120 includes a plurality of terminal block connectors for connecting conductors of 1126, 1128 of SPE cables 1122, 1124. In this embodiment, the SPE cables are unshielded. The jumpers 1130 are connected to adjacent white terminal block connectors. The jumpers 1130 combined with the structure of the white terminal block connectors act as the potential equalizing element structurally configured to provide an equal potential to at the white terminal block connectors and are configured to provide the balanced level of crosstalk. An optional white terminal block connector 1132 has been added at the end of the row of terminal block connectors as discussed herein.

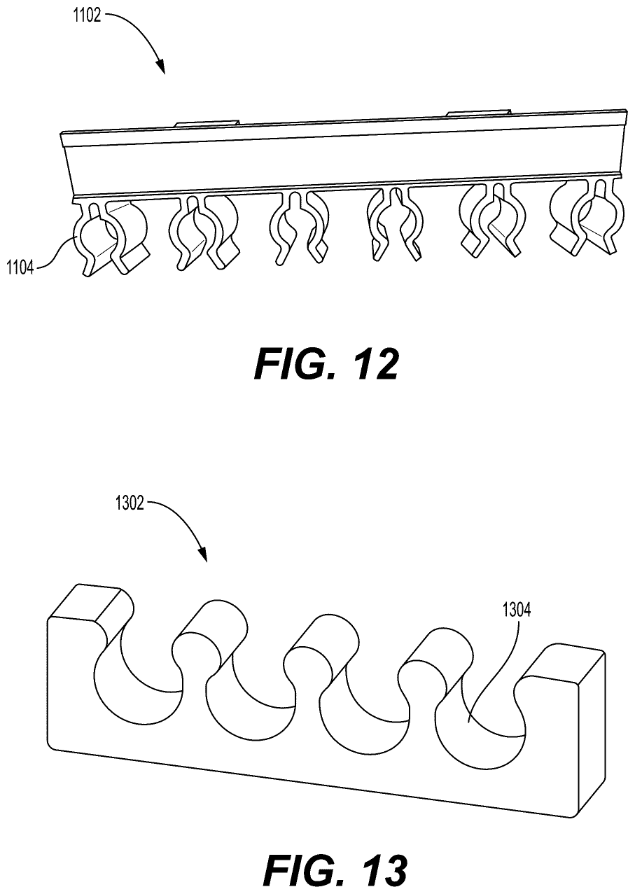

The potential equalizing element may be implemented in various ways. As shown in FIGS. 12 and 13, a potential equalizing element 1202, 1302 may be utilized in accordance with various embodiments. The potential equalizing element 1202 may include a semi-rigid finger or collar 1204, 1304 with a metallic coating to create an electrical connection between the shield conductors of each pair. This potential equalizing element 1202, 1302 would require the cabling to be shielded because the shield conductor of the cable would be used to connect to the gray terminal block, and this product would serve as the shunt.

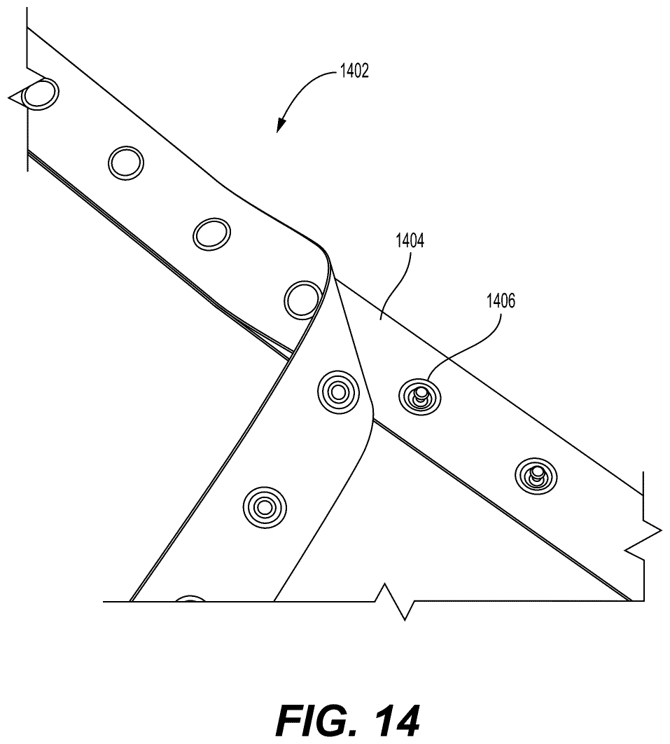

As illustrated in FIG. 14, another potential equalizing element 700 may include a pair of flexible metallic strips 1402 having snaps 1404 such that they can be connected. The snaps 1404 may be spaced corresponding to the gaps between the cables entering the terminal blocks. See picture below, the white material would be made of a metallic material.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A coupling device configured to balance electrical coupling of a single pair ethernet cable to a data conductor portion connected with a terminal block connector portion, comprising:
a connecting portion structurally configured to connect to a shield portion of a single pair ethernet cable;
an extension portion configured to extend from the connecting portion;
wherein the extension portion includes a first extension portion and a second extension portion configured to extend along a first data conductor portion of the single pair ethernet cable and along a second data conductor portion of the single pair ethernet cable, respectively;
wherein the first extension portion is configured to be connected within at least a portion of a first terminal block connector portion that is configured to be located adjacent to a second terminal block connector portion that is configured to be connected with the first data conductor portion of the single pair ethernet cable;
wherein the second extension portion is configured to be connected within at least a portion of a third terminal block connector portion that is configured to be located adjacent to a fourth terminal block connector portion that is configured to be connected with the second data conductor portion of the single pair ethernet cable;
wherein the fourth terminal block connector portion is configured to be located adjacent to the third terminal block connector portion; and
wherein the first extension portion and the first data conductor portion are configured to form a first spacing portion and a first electrical coupling level;
wherein the second extension portion and the second data conductor portion are configured to form a second spacing portion and a second electrical coupling level; and
wherein the first spacing portion and the second spacing portion are configured such that the first electrical coupling level is balanced with the second electrical coupling level so as to reduce alien crosstalk of a single pair ethernet cabling system.

2. The coupling device of claim 1, wherein the connecting portion and the extension portion comprise a conductive material configured to provide electrical coupling.

3. The coupling device of claim 1, wherein the connecting portion has a semicircular shape configured to be positioned around a shield portion of the single pair ethernet cable.

4. The coupling device of claim 3, wherein the semicircular shape includes a gap that is configured to allow clamping of the connection portion to the shield portion of the single pair ethernet cable.

5. The coupling device of claim 1, wherein the coupling device is configured to reduce the alien crosstalk of the single pair ethernet cabling system.

6. The coupling device of claim 5, wherein the coupling device is configured to reduce the alien crosstalk by 3 dB or more.

7. The coupling device of claim 1, wherein the first extension portion and the second extension portion are configured to extend substantially parallel to the first data conductor portion and the second data conductor portion, respectively.

8. The coupling device of claim 1, wherein the first spacing portion and the second spacing portion have a spacing equal to a width of the first terminal block connector portion.

9. A coupling device configured to balance electrical coupling of a single pair ethernet cable to a data conductor portion connected with a terminal block connector portion, comprising:
a connecting portion structurally configured to connect to a shield portion of a single pair ethernet cable;
an extension portion configured to extend from the connecting portion;
wherein the extension portion includes a first extension portion and a second extension portion configured to extend along a first data conductor portion of the single pair ethernet cable and along a second data conductor portion of the single pair ethernet cable, respectively;
wherein the first extension portion is configured to be connected within at least a portion of a first terminal block connector portion that is configured to be located adjacent to a second terminal block connector portion that is configured to be connected with the first data conductor portion of the single pair ethernet cable;
wherein the second extension portion is configured to be connected within at least a portion of a third terminal block connector portion that is configured to be located adjacent to a fourth terminal block connector portion that is connected with the second data conductor of the single pair ethernet cable;
wherein the fourth terminal block connector portion is configured to be located adjacent to the third terminal block connector portion; and
wherein the coupling device is configured such that electrical coupling of the first data conductor portion to the first extension portion is balanced with electrical coupling of the second data conductor portion to the second extension portion so as to reduce alien crosstalk of a single pair ethernet cabling system.

10. The coupling device of claim 9, wherein the connecting portion and the extension comprise a conductive material configured to provide electrical coupling.

11. The coupling device of claim 9, wherein the connecting portion has a semicircular shape configured to be positioned around a shield portion of the single pair ethernet cable.

12. The coupling device of claim 11, wherein the semicircular shape includes a gap that is configured to allow clamping of the connection portion to the shield portion of the single pair ethernet cable.

13. The coupling device of claim 9, wherein the balancing device is configured to reduce the alien crosstalk of the single pair ethernet cabling system.

14. The coupling device of claim 13, wherein the coupling device is configured to reduce the alien crosstalk by 3 dB or more.

15. The coupling device of claim 9, wherein the first extension portion and the second extension portion are configured to extend substantially parallel to the first data conductor portion and the second data conductor portion, respectively.

16. The coupling device of claim 9, wherein a first spacing portion between the first extension portion and the first data conductor portion and a second spacing portion between the second extension portion and the second data conductor have a spacing equal to a width of the first terminal block connector portion.

17. A coupling device configured to balance electrical coupling of a single pair ethernet cable to a data conductor portion connected with a terminal block connector portion, comprising:
a connecting portion structurally configured to connect to a shield portion of the single pair ethernet cable;
an extension portion configured to extend from the connecting portion;
wherein the extension portion includes a first extension portion and a second extension portion;
wherein the first extension portion is configured to be connected within at least a portion of a first terminal block connector portion that is configured to be located adjacent to a second terminal block connector portion that is configured to be connected with a first data conductor portion of the single pair ethernet cable;
wherein the second extension portion is configured to be connected within at least a portion of a third terminal block connector portion that is configured to be located adjacent to a fourth terminal block connector portion that is connected with a second data conductor of the single pair ethernet cable;
wherein the fourth terminal block connector portion is configured to be located adjacent to the third terminal block connector portion; and
wherein the first extension portion and the second extension portion are configured such that the coupling of the first data conductor is balanced with the coupling of the second data conductor so as to reduce alien crosstalk of a single pair ethernet cabling system.

18. The coupling device of claim 17, wherein the first extension portion and the second extension portion extend substantially parallel to the first and second data conductors of the single pair ethernet cable.

19. The coupling device of claim 17, wherein electrical coupling of the first data conductor portion to the first extension portion is balanced with the coupling of the second data conductor portion to the second extension portion to reduce the alien crosstalk of the single pair ethernet cabling system.

20. The coupling device of claim 17, wherein the connecting portion and the extension portion comprise a conductive material configured to provide electrical coupling.

21. The coupling device of claim 17, wherein the connecting portion has a semicircular shape configured to be positioned around a shield portion of the single pair ethernet cable.

22. The coupling device of claim 21, wherein the semicircular shape includes a gap that is configured to allow clamping of the connection portion to the shield portion of the single pair ethernet cable.

23. The coupling device of claim 17, wherein the coupling device is configured to reduce a level of the alien crosstalk of the single pair ethernet cabling system.

24. The coupling device of claim 23, wherein the coupling device is configured to reduce the alien crosstalk by 3 dB or more.

25. The coupling device of claim 17, wherein the first extension portion and the second extension portion are configured to extend substantially parallel to the first data conductor portion and the second data conductor portion, respectively.

26. The coupling device of claim 17, wherein a first spacing portion between the first extension portion and the first data conductor portion and a second spacing portion between the second extension portion and the second data conductor have a spacing equal to a width of the first terminal block connector portion.
